(19) United States
(12) Patent Application Publication
(10) Pub. No.: US 2006/0249506 A1
(43) Pub. Date: Nov. 9, 2006

(54) Grill with interchangeable cooking plates

(76) Inventor: Ruairidh Robertson, Nantucket, MA (US)

Correspondence Address: LITMAN LAW OFFICES, LTD, PO BOX 15035, CRYSTAL CITY STATION, ARLINGTON, VA, 22215, US

(21) Appl. No.: 10/865,863

(22) Filed: Jun. 14, 2004

(51) Int. Cl. H05B 3/68; H05B 3/06

(52) U.S. Cl. 219/450.1; 219/524

(57) ABSTRACT

An electric grilling appliance having interchangeable cooking plates. The appliance is of the table-top genre and has a top configured as a clam shell for aesthetic purposes. An electric heating element is disposed in the lower portion of the appliance. A first cooking plate or surface is positioned in the lower portion above and immediately adjacent the heating element. A second cooking plate is positioned in the upper portion above the first cooking plate. Both cooking plates are easily removed from the housing and replaced with plates having different food receiving contours.

### BACKGROUND OF THE INVENTION

1. Field of the Invention

The present invention generally relates to cooking appliances. More specifically, the present invention is drawn to an electric grill with removable and interchangeable grill plates.

2. Description of the Related Art

In the busy, rush-rush modern world, time allotted for cooking has been relegated to the “back burner”. People are constantly seeking a single, “supreme” appliance that can perform a variety of cooking functions quickly, efficiently and still produce a plethora of healthy foods that is satisfying to one's palate and aesthetically pleasing.

There are many devices in the related art that attempt to achieve the title of “supreme” appliance. For example, U.S. Pat. No. 1,587,788 (Morley) and U.S. Pat. No. 6,555,795 B2 (Glucksman et al.) disclose cooking utensils having reversible inserts with different molds on opposed surfaces. The patents do not discuss provision of interchangeable molds. Furthermore the patents are only concerned with cooking batter-based foods such as cakes, donuts and waffles.

U.S. Pat. No. 5,380,986 (Mullen) is drawn to a multi-purpose electric appliance utilized to cook a variety of foods by different methods. The appliance does not employ interchangeable cooking plates.

U.S. Patent Application Publication numbered 2004/0050256 A1 (Patenotre) shows an appliance having removable cooking plates. However, the patentee does not contemplate utilizing combination cooking plates and providing a removable grease tray beneath the bottom cooking plate.

U.S. Pat. No. 5,606,905 (Boehm et. al.) discloses a cooking appliance having downwardly sloping cooking plates. A separate receptacle is positioned at the front of the appliance for collecting grease drippings. The cooking plates are not removable for interchange with other cook plates.

U.S. Pat. No. 6,429,409 B1 (Siu) shows a grill having removable, interchangeable cooking plates. Siu does not contemplate a removable grease tray.

None of the above inventions and patents, taken either singly or in combination, is seen to disclose a cooking appliance having interchangeable cooking plates and a removable grease tray as will subsequently be described and claimed in the instant invention.

### SUMMARY OF THE INVENTION

The present invention is an electric grilling appliance having interchangeable cooking plates. The appliance is of the table-top genre and has a top configured as a clam shell for aesthetic purposes. Upper and lower portions are hinged at the rear thereof to form a housing that is opened and closed as is a conventional waffle iron or sandwich grill. An electric heating element is disposed in the lower portion of the housing. A first cooking plate or surface is positioned in the lower portion above and immediately adjacent the heating element. A second cooking plate is positioned in the upper portion above the first cooking plate. Both cooking plates are easily removed from the housing and replaced with different plates, which plates are contoured to receive different foods. For example, one set of plates may have hemispherical depressions for receiving and cooking meatballs; another set of plates may contoured to cook waffles; a third set of plates may have circular depressions for cooking pancakes. The variety of contoured sets plates is limited only by the kinds of foods that one can grill or bake (hamburgers, hotdogs, corn-on-the-cob, biscuits, etc.). Furthermore, as contemplated, some sets of cooking plates will be fabricated in combination form whereby two different foods may be cooked simultaneously. For example, a combination set may incorporate contours for waffles and pancakes while another set may have contours for sausages and an omelet; here again, the combinations are endless.

A removable grease tray is positioned in the lower portion of the housing beneath the first cooking plate. An array of apertures or weep holes is provided through the surface of the lower cooking plate to drain away grease from food. All the removal cooking plates and the removable grease tray are designed to be dishwasher safe. Timer and temperature controls are positioned on the appliance so that the cooking environment may be easily regulated.

Accordingly, the invention presents an electrical appliance, which appliance is provided with a variety of removable and interchangeable cooking plates. The cooking plates are contoured to accommodate different foods and include combination plates whereby two different foods may be cooked simultaneously. A removable tray is provided to receive liquids (grease) that drip from the cooking foods. The appliance is adapted for table top use and is configured in an aesthetically pleasing design. Timer and temperature controls are disposed on the appliance to regulate the cooking process.

The invention provides for improved elements and arrangements thereof for the purposes described which are inexpensive, dependable and fully effective in accomplishing their intended purposes.

A clear understanding of the present invention will become readily apparent upon further review of the following specification and drawings.

### BRIEF DESCRIPTION OF THE DRAWINGS

FIG. 1 is a perspective view of a grill with interchangeable cooking plates according to the present invention.

FIG. 2 is a sectional, side view of a grill with interchangeable cooking plates according to the present invention.

FIG. 3 is a sectional, rear view of a grill with interchangeable cooking plates according to the present invention.

FIG. 4 is a top view of a lower hamburger grill insert of a grill with interchangeable cooking plates according to the present invention.

FIG. 5 is an end view of grease tray of a grill with interchangeable cooking plates according to the present invention.

FIG. 6 is a top view of a combination grill insert of a grill with interchangeable cooking plates according to the present invention.

FIG. 7 is a side view of a meatball grill insert of a grill with interchangeable cooking plates according to the present invention.

Similar reference characters denote corresponding features consistently throughout the attached drawings.

### DETAILED DESCRIPTION OF THE PREFERRED EMBODIMENTS

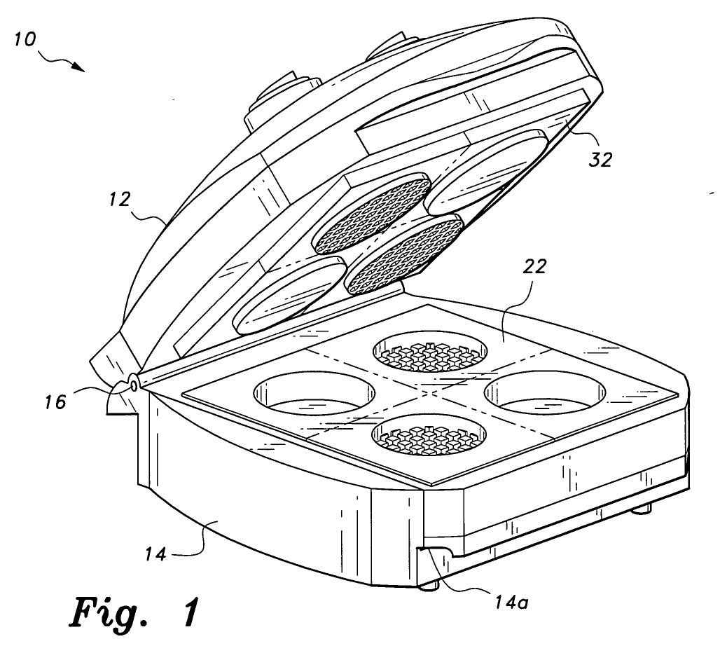

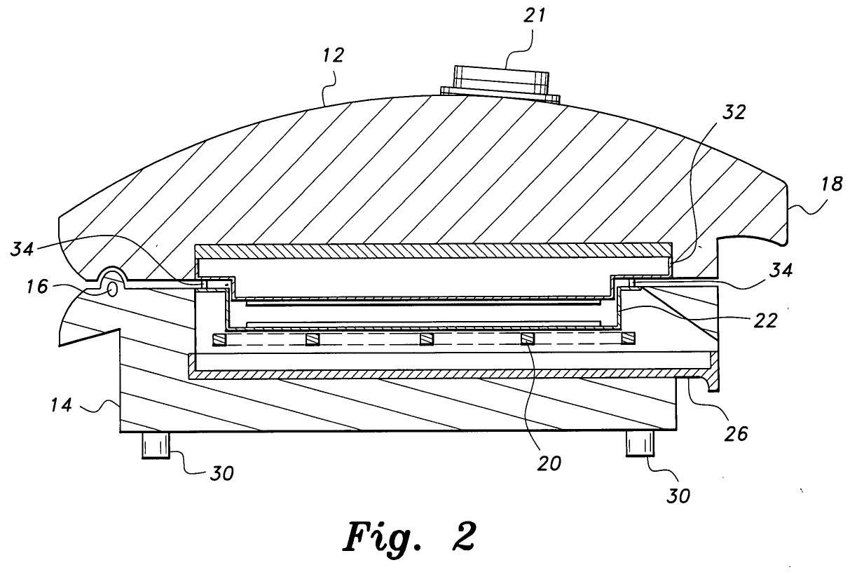

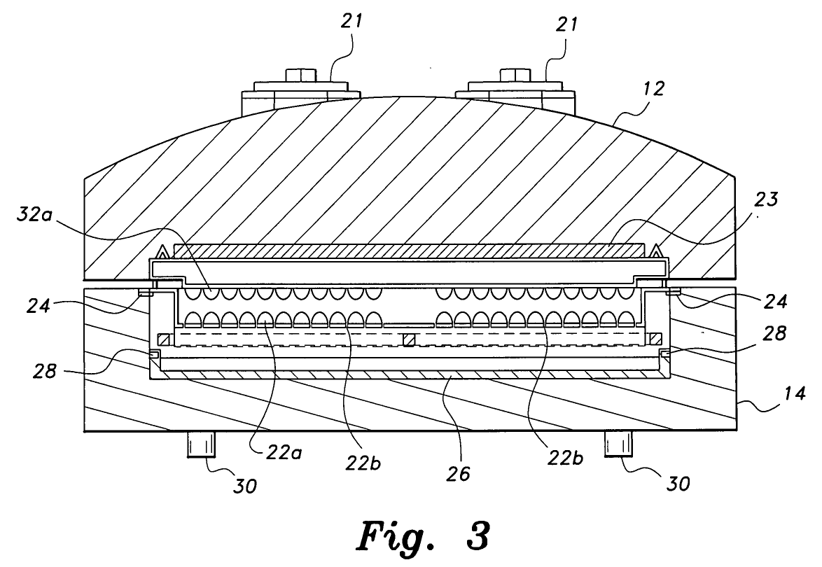

Attention is first directed to FIGS. 1-3 wherein the appliance of the present invention is generally indicated at 10. Appliance 10 includes a top shell member 12 and a bottom shell member 14. Each shell member 12, 14 has walls enclosing a space. A self-adjusting hinge 16 joins shell members 12 and 14 at their rear ends. A handle 18 defines the front end of top shell member 12. Top shell member 12 is of clam-shaped configuration to give a more aesthetically pleasing appearance to the appliance.

Bottom shell member 14 has an electric heating element 20 disposed therein. A heating element 23 is mounted in top shell member 12. Heating elements 20 and 23 are appropriately wired in a conventional manner. Conventional timer and temperature controls 21 are conveniently positioned on the outer surface of top shell 12. A lower cooking or grilling plate insert 22 is supported in member 14 immediately above heating element 20. The peripheral edge of cooking plate 22 rests on a heat resistant bracket 24, which bracket 24 defines the top edge of bottom shell member 14. A grease tray 26 is positioned below heating unit 20. Grease tray 26 is adapted for sliding movement on runners 28, which runners are fixed to the bottom shell member. Grease tray 26 is removable through an opening 14a formed in the front end of shell member 14. A plurality of feet (four) 30 is provided to support the appliance on a planar, level surface. An upper cooking or grilling plate insert 32 is disposed in top shell member 12 and is removably supported therein in any conventional and convenient manner. Stops 34 provide separation between the upper and lower inserts when the appliance is closed.

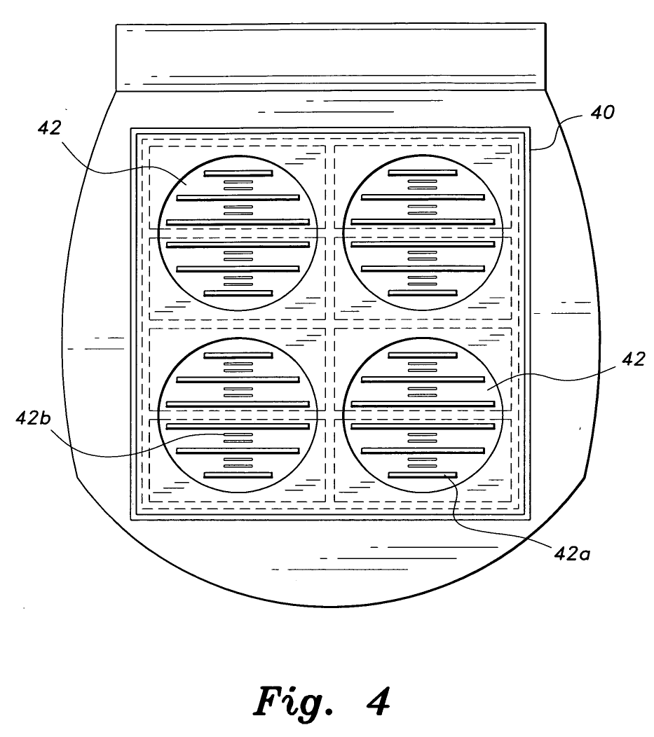

As indicated above, the upper and lower cooking plates 22, 32 are designed to be removable and interchangeable with a variety of other cooking plates. All of the interchangeable cooking plates will have the same width and length. As presently contemplated, these dimensions are ten by ten and one-eighth inches. Insert plates 22, 32 are grilling plates and include raised edges 22a, 32a, which raised edges extend perpendicularly from the cooking surfaces of the plates and function to give the food a grilled effect. An array of weep holes 22b allows grease to drip into grease tray 26. FIG. 4 illustrates a plan view of a lower hamburger grilling plate 40. Plate 40 is provided with circular cavities 42 which allow the hamburger to retain its classical shape. Alternate raised edges 42a and weep holes 42b are positioned on the bottom of each cavity 42.

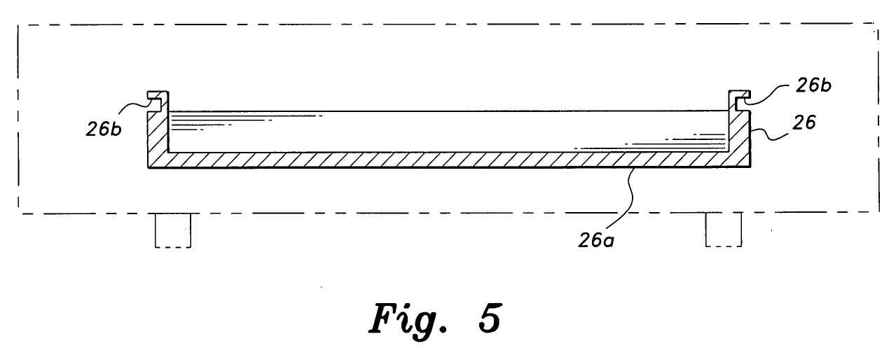

FIG. 5 shows an end view of grease tray 26. Grease tray 26 is fashioned with a planar solid bottom wall 26a, which wall is substantially underlies the entire area of the lower grill insert. Tray 26 includes tracks 26b that are adapted to slide on runners 28.

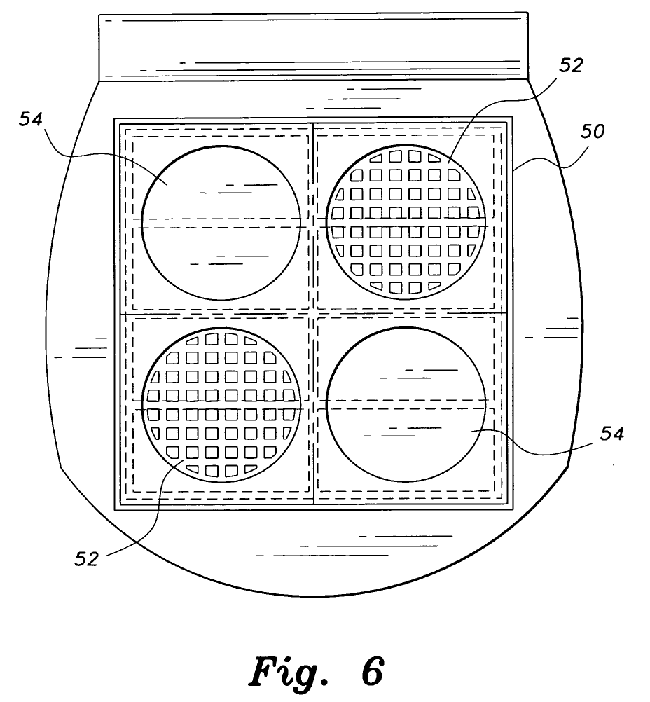

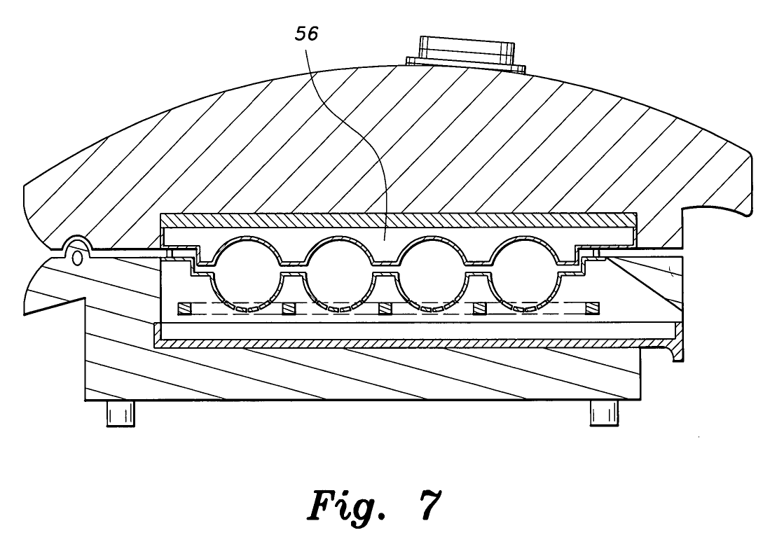

FIG. 6 is illustrative of a combination interchangeable grill insert 50. The combination insert permits the user to cook different foods simultaneously. As shown, the insert is contoured for waffles at 52 and for pancakes at 54. FIG. 7 shows inserts hemispherically contoured at 56 to cook meatballs. Again, it is emphasized that the variety of inserts is limited only by the number foods that may be grilled.

It is understood that the present invention is not limited to the embodiments described above, but encompass any and all embodiments within the scope of the following claims.

1. A tabletop appliance having interchangeable grilling inserts comprising:
a top shell member having a front end and a rear end;
a bottom shell member having a front end including an opening and a rear end;
a self-adjusting hinge attached to said rear end of said top shell member and said rear end of said bottom shell member;
an upper grilling insert removably positioned in said top shell member;
a lower grilling insert removably positioned in said bottom shell member, wherein said lower grilling insert has a cooking surface and an array of weep holes disposed through the cooking surface;
an electric heating element positioned in said bottom shell member immediately below said lower grilling insert; and
a grease tray removable through the opening in the front end of said bottom shell, said grease tray being positioned in said bottom shell immediately below said electric heating element and substantially underlying the entire cooking surface of said lower grilling insert.

2. (canceled)

3. A tabletop appliance having interchangeable grilling inserts as recited in claim 1, wherein said top shell member has an outer surface and including timer and temperature controls positioned on said outer surface.

4. A tabletop appliance having interchangeable grilling inserts as recited in claim 1, wherein said bottom shell member has a pair of runners attached thereto and wherein said grease tray is slidable on said runners.

5. A tabletop appliance having interchangeable grilling inserts as recited in claim 1, wherein said bottom shell member has a top edge and wherein a heat resistant bracket defines said top edge.

6. A tabletop appliance having interchangeable grilling inserts as recited in claim 5, wherein said lower grilling insert has a peripheral edge and wherein said peripheral edge is disposed on said heat resistant bracket.

7. A tabletop appliance having interchangeable grilling inserts as recited in claim 1, including a handle positioned on said front end of said top shell member.

8. A tabletop appliance having interchangeable grilling inserts as recited in claim 1, wherein said lower grilling insert includes an array of raised grilling edges extending perpendicularly from said cooking surface.

9. (canceled)

10. A tabletop appliance having interchangeable grilling inserts as recited in claim 8, wherein said upper grilling insert has a cooking surface and an array of raised grilling edges extending perpendicularly from said cooking surface of said upper cooking insert.

11. A tabletop appliance having interchangeable grilling inserts comprising:
a top shell member having a front end including an opening and a rear end;
a bottom shell member having a front end and a rear end;
a self-adjusting hinge attached to said rear end of said top shell member and said rear end of said bottom shell member;
a first upper grilling insert removably positioned in said top shell member, said first upper grilling insert member having a cooking surface contoured to receive and cook a first particular food;
a first lower grilling insert removably positioned in said bottom shell member, said first lower grilling insert member having a cooking surface with an array of weep holes disposed therethrough, the cooking surface of said first lower grilling insert being contoured to receive and cook said first particular food;
an electric heating element positioned in said bottom shell member immediately below said lower grilling insert; and
a grease tray removable through the opening in the front end of said bottom shell, said grease tray being positioned immediately below said electric heating element and substantially underlying the entire cooking surface of said lower grilling insert.

12. A tabletop appliance having interchangeable grilling inserts recited in claim 11, including a second upper grilling insert interchangeable with said first upper grilling insert, said second upper grilling insert removably positioned in said top shell member, said second upper grilling insert member having a cooking surface contoured to receive and cook a second particular food and a second lower grilling insert interchangeable with said first lower grilling insert, said second lower grilling insert removably positioned in said bottom shell member, said second lower grilling insert member having a cooking surface contoured to receive and cook said second particular food.

13. A tabletop appliance having interchangeable grilling inserts recited in claim 12, wherein said cooking surface of said second upper grilling insert and said cooking surface of said second lower grilling surface have circular indentations therein for cooking hamburgers.

14. A tabletop appliance having interchangeable grilling inserts recited in claim 12, wherein said cooking surface of said second upper grilling insert and said cooking surface of said second lower grilling surface have hemispherical indentations therein for cooking meatballs.

15. A tabletop appliance having interchangeable grilling inserts comprising:
a top shell member having a front end and a rear end;
a bottom shell member having a front end including an opening and a rear end;
a self-adjusting hinge attached to said rear end of said top shell member and said rear end of said bottom shell member;
a first upper grilling insert removably positioned in said top shell member, said first upper grilling insert member having a cooking surface contoured to receive and cook simultaneously a combination of a first particular food and a second particular food wherein said second particular food is different from said first particular food;
a first lower grilling insert removably positioned in said bottom shell member, said first lower grilling insert member having a cooking surface with an array of weep holes disposed therethrough, the cooking surface of said first lower grilling insert being contoured to receive and cook simultaneously said first particular food and said second particular food;
an electric heating element positioned in said bottom shell member immediately below said lower grilling insert; and
a grease tray removable through the opening in the front end of said bottom shell said grease tray being positioned immediately below said electric heating element and substantially underlying the entire cooking surface of said lower grilling insert.
